(19) United States
(12) Patent Application Publication
(10) Pub. No.: US 2002/0196737 A1
(43) Pub. Date: Dec. 26, 2002

(54) Capture and use of service identifiers and service labels in flow activity to determine provisioned service for datagrams in the captured flow activity

(75) Inventor: Wm. Carter Bullard, New York, NY (US)

Correspondence Address: AKIN, GUMP, STRAUSS, HAUER & FELD, L.L.P., ONE COMMERCE SQUARE, SUITE 2200, 2005 MARKET STREET, PHILADELPHIA, PA, 19103, US

(73) Assignee: Qosient LLC

(21) Appl. No.: 09/879,430

(22) Filed: Jun. 12, 2001

(51) Int. Cl. H04L 12/26

(52) U.S. Cl. 370/231; 370/395.2

(57) ABSTRACT

Flow activity of selected traffic is captured between a source and a destination at selected states and points in time during a communication session between nodes of a service network. The flow activity includes a flow descriptor for selected datagrams placed in the service network. The flow activity also includes either a service identifier for the selected datagrams which identifies a service interface in the service network that the datagram is transmitted to or received from, or any service labels that are within or appended to the selected datagrams, wherein the service labels reference the service to be given to the datagrams. The service being provisioned on predefined service interfaces is identified. The identified provisioned service and the service identifiers or service labels are used to determine the service provisioned for the datagrams associated with the captured flow activity.

### BACKGROUND OF THE INVENTION

Network service assurance refers to the process of verifying or auditing a service network to determine if the service network is operating in the intended manner and is providing the expected service. One conventional technique of performing service assurance is to conduct packet analysis on datagrams at an interface of the service network or in the service network. Typically, a packet analyzer is used for this process. At very high data rates, such as at the gigabit level, packet analysis is not feasible. Other types of network measurement tools have been developed to measure and analyze network performance at high data rates. One such tool is the “flow meter,” also referred to as a “real time flow monitor” (RTFM). The flow meter tracks and reports on the status and performance of network streams or groups of related packets seen in an Internet Protocol (IP) traffic stream. A flow meter does not perform packet capture. That is, a flow meter is not a packet collector. Instead, a flow meter captures abstractions of the traffic, not the traffic itself.

Flow meter data or output is collected, processed and stored in or by flow collectors. One conventional flow meter and collector is known as ARGUS, and is commercially available from Qosient, LLC, New York, N.Y. ARGUS provides a common data format for reporting flow metrics such as connectivity, capacity and responsiveness, for all flows, on a per transaction basis. The network transaction audit data that ARGUS generates has been used for a wide range of tasks including security management, network billing and accounting, network operations management, and performance analysis. In a conventional configuration, one flow collector is used, and may be situated either inside a service network or outside of a service network.

One type of ARGUS record is a Flow Activity Record (FAR). The FAR provides information about network transaction flows that ARGUS tracks. A FAR has a flow descriptor and some activity metrics bounded over a time range. More specifically, each FAR has an ARGUS transaction identifier, a time range descriptor (start time and duration in microseconds), a flow descriptor and flow metrics. One basic type of flow descriptor is a flow key descriptor which includes source and destination addresses, type of protocol (e.g., TCP), and service access ports (e.g., source DSAP, SSAP). Another type of flow descriptor is a DiffServ (DS) byte or type of service (ToS) field label. Some flow metrics include src and dst packets, network and application bytes, and interpacket arrival time information. ARGUS specifications and the format of a prior art ARGUS FAR are shown in the Appendix below.

Another flow collector that may be used for network data analysis and service auditing is the “NetFlow FlowCollector,” commercially available from Cisco Systems, Inc., San Jose, Calif. NetFlow traffic describes details such as source and destination addresses, autonomous system numbers, port addresses, time of day, number of packets, bytes and type of service.

Conventional flow collectors and other types of traffic monitoring devices provide many useful service auditing functions. However, there are still many types of audit data that are not available when using conventional flow collectors and implementations thereof. The present invention captures additional data in flow collectors and uses the additional data, in conjunction with other network data, to provide enhanced service network auditing functions.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there is shown in the drawings an embodiment that is presently preferred. It should be understood, however, that the invention is not limited to the precise arrangements and instrumentalities shown. In the drawings:

FIG. 1 is a schematic block diagram of a network system having service assurance elements in accordance with a first embodiment of the present invention;

FIG. 2 shows selected content of flow activity records stored in a flow collector for use in the system of the present invention;

FIG. 3 shows a portion of a prior art service resource allocation audit which is continuously created in dynamic service networks;

FIG. 4 shows a portion of a prior art configuration file which is used in a non-dynamic (static) service network;

FIG. 5 shows a self-explanatory flowchart of an ingress/egress comparison process used for symmetric nodes in accordance with the present invention;

FIG. 6 is a schematic block diagram of a network system having service assurance elements in accordance with an alternative version of the first embodiment of the present invention;

FIG. 7 shows selected content of flow activity records stored in a flow collector in accordance with a second embodiment of the present invention;

FIG. 8 shows a service label file for one particular service network for use with the second embodiment of the present invention;

FIG. 9 is a schematic block diagram of a plural service network system having service assurance elements in accordance with a third embodiment of the present invention;

FIG. 10 is a schematic block diagram of a plural service network system having service assurance elements in accordance with a fourth embodiment of the present invention; and

FIG. 11 is a schematic block diagram of a network system having an asymmetric, unidirectional service network node, and service assurance elements in accordance with a fifth embodiment of the present invention.

### BRIEF SUMMARY OF THE INVENTION

The present invention provides a method of auditing a communication session between a source connected to a first node of a service network and a destination connected to a second node of the service network. In the method, flow activity of selected traffic is captured between the source and the destination at selected states and points in time during the communication session. The flow activity includes a flow descriptor for selected datagrams placed in the service network, as well as a service identifier for the selected datagrams which identifies a service interface in the service network that the datagram is transmitted to or received from. The service being provisioned on predefined service interfaces is identified. Then, the identified provisioned service and the service identifiers are used to determine the service provisioned for the datagrams associated with the captured flow activity.

In another embodiment of the present invention, the captured flow activity includes any service labels that are within or appended to the selected datagrams. The service labels reference the service to be given to the datagram. In this embodiment, a provisioned service being referenced by the service label identified. Then, the identified provisioned service and the service labels of the captured flow activity are used to determine the services provisioned for the datagrams associated with the captured flow activity.

### DETAILED DESCRIPTION OF THE INVENTION

Certain terminology is used herein for convenience only and is not to be taken as a limitation on the present invention. In the drawings, the same reference letters are employed for designating the same elements throughout the several figures.

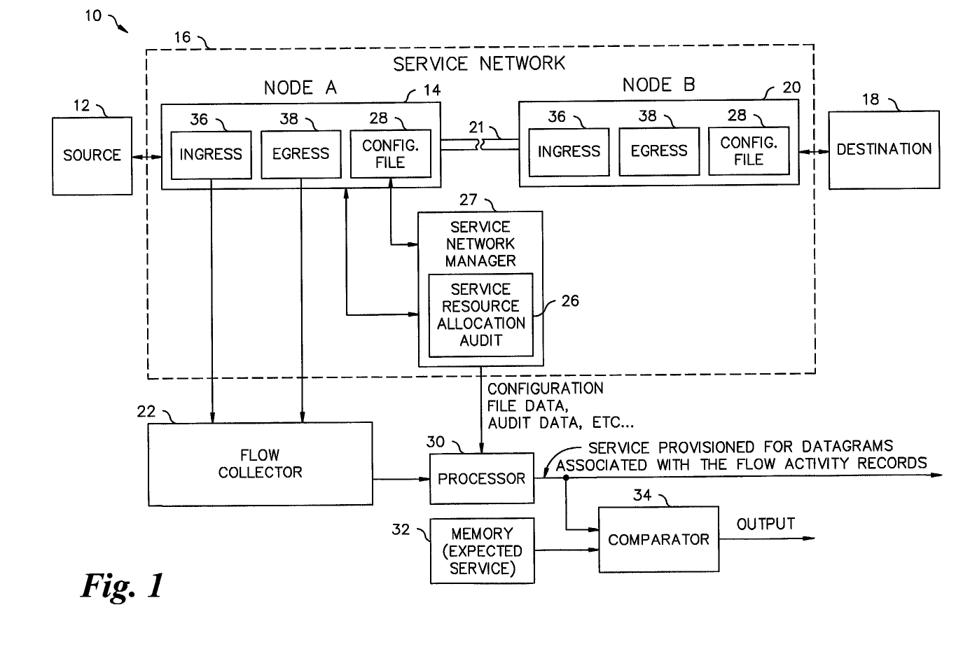

FIG. 1 shows a system 10 in accordance with a first embodiment of the present invention. The system 10 audits a communication session between a source 12 connected to a first node 14 (node A) of a service network 16 and a destination 18 connected to a second node 20 (node B) of the service network 16. Nodes A and B of the service network 16 are connected to each other via a communication path 21. In the system 10, flow activity of selected traffic is captured between the source 12 and the destination 18 at selected states and points in time during the communication session. The captured flow activity includes a flow descriptor for selected datagrams placed in the service network, and a service identifier for the selected datagrams which identifies a service interface in the service network that the datagram is transmitted to or received from. The flow activity is stored in time-stamped flow activity records of at least one flow collector 22. The records are used to audit the delivery of services in the service network 16.

Nodes A and B abstractly represent the ingress and egress interfaces for the flow into and out of the service network 16. Thus, for example, node A maybe one physical node, or may be a plurality of nodes such as two unidirectional nodes which together allow for bidirectional flow. If node A represents a plurality of nodes, the nodes may be in one physical location or facility, or may be physically dispersed among plural locations or facilities.

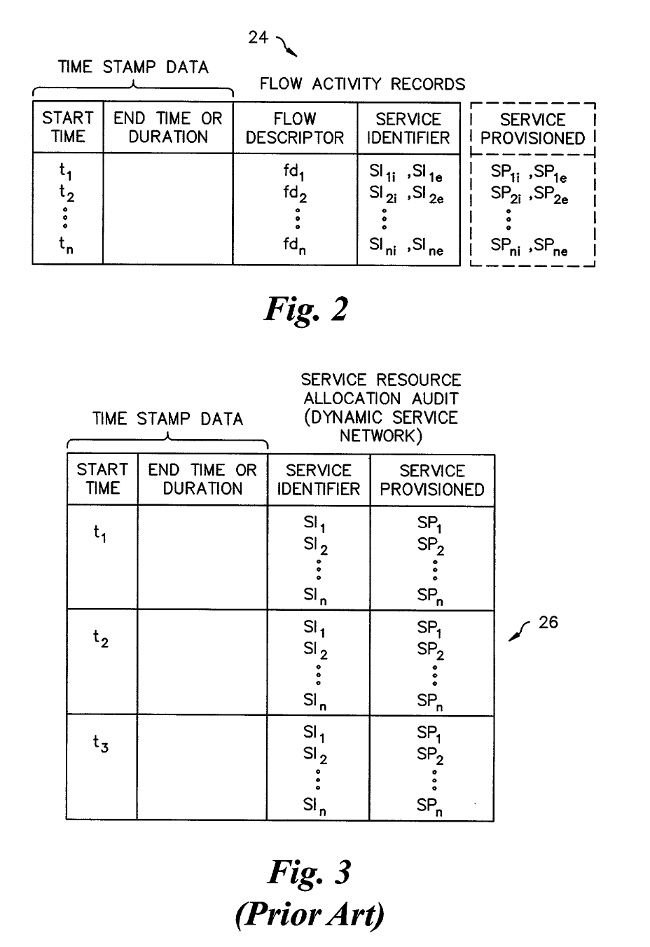

FIG. 2 shows selected content of flow activity records 24 stored in the flow collector 22. Each flow activity record entry has time stamp data, a flow descriptor, service identifier data, and performance metrics (not shown). The time stamp data includes a start time, and a stop time or a duration of time from the start time. In a bidirectional flow collector, the flow descriptor accounts for corresponding ingress and egress flows, and service identifiers for each direction of flow (labeled as SIᵢ and SIₑ). The present invention is described in the context of a bidirectional flow collector. In a unidirectional flow collector, the flow descriptor accounts for only one flow (either ingress or egress), and only the service identifier for the one flow. To obtain the complete flow record when using unidirectional flow collectors, records from the two unidirectional flow collectors (each capturing one-half of the flow) must be correlated or merged. The scope of the present invention includes embodiments that use unidirectional flow collectors.

FIG. 3 shows a portion of a prior art service resource allocation audit 26 which is continuously created in dynamic service networks. The audit 26 specifies the service being provisioned (i.e., the service intended to be provided) on interfaces of a service network at selected periods of time. Each audit record has time stamp data, a service identifier (labeled as SI), and a provisioned service that is referenced by the service identifier (labeled as SP). In a dynamic service network 16, the present invention uses the time stamp data and the service identifier data of the audit 26 and of the flow activity records 24 to identify the service provisioned to a particular flow. The audit 26 is maintained by service network manager 27.

Referring to FIG. 1, in a dynamic service network, data from the audit 26 are communicated to a processor 30 which also receives record data from the flow collector 22. The processor 30 uses the time stamp data and service identifiers of the flow activity records 24 and the time stamp data and the service identifiers of the audit records to correlate the audit data with the flow activity record data. In this manner, the processor 30 can identify the service provisioned for the datagrams associated with the flow descriptors of each flow activity record 24. See the last column of FIG. 2 which shows the “service provisioned” information in dashed lines to help illustrate this feature. The ingress service provisioned is labeled as SPᵢ, and the egress service provisioned is labeled as SPₑ. The “service provisioned” information is not actually part of the flow activity records 24. However, in an alternative embodiment of the present invention, the “service provisioned” information may be added as another field of a flow activity record 24 after the information is determined from the process described above.

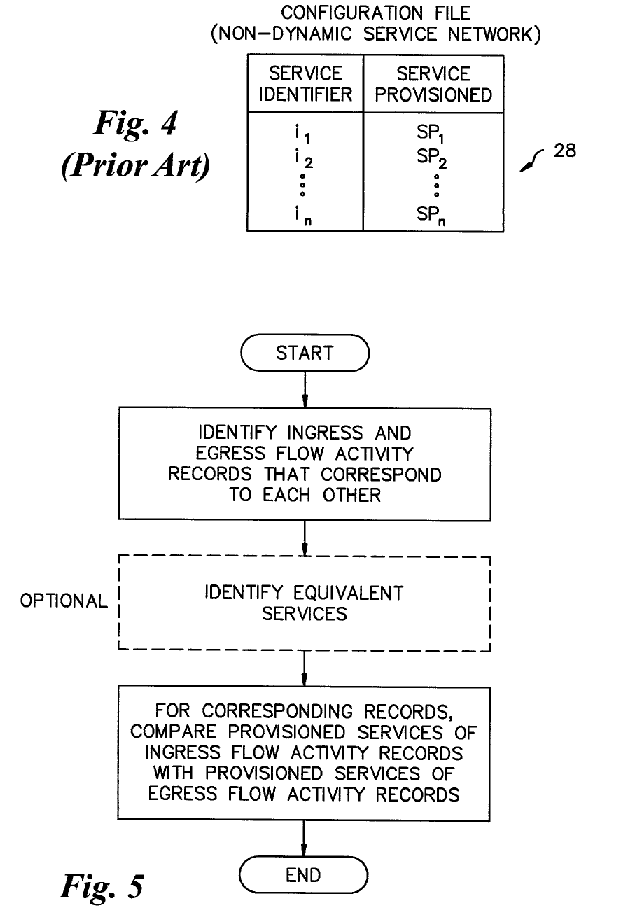

FIG. 4 shows a portion of a prior art configuration file 28 which is used in a non-dynamic (static) service network. The configuration file 28 lists the service provisioned on each interface. Unlike the dynamic service network, the service provisioned by each node in a static service network does not change over a time period. A service change must be made by editing the configuration file 28 via the service network manager 27. In a static service network 16, the data in the configuration file 28 is used to identify the service corresponding to the service identifier of the flow activity records 24 (labeled as SP). Each node of a service network has a configuration file 28 associated therewith.

Referring to FIG. 1, in a static service network, there is a configuration file 28 in each of the nodes A and B. The configuration file 28 may also be considered as an element of the service network manager 27. The data in the configuration file 28 of node A is communicated to the processor 30 as part of the data flow from the service network manager 27 to the processor 30. The processor 30 uses the service identifiers of the flow activity records 24 and the static service identifiers of the configuration file 28 to identify the service provided for the datagrams associated with the flow descriptors of each flow activity record 24. Thus, the information in the last column of FIG. 2 may also be obtained in a static service network.

Another set of service assurance elements (not shown) may be active at node B. That is, there may a flow collector 22, an audit 26 of node B activity (in a dynamic service network), configuration file 28 (in a static service network), a processor 30, a memory 34, and a comparator 34 associated with node B.

One key purpose of the present invention is to determine if datagrams are receiving the service or services that a customer is expecting to receive, or has paid to receive. Thus, a memory 32 may be provided for storing an expected service for the traffic between the source 12 and the destination 18. A first input of a comparator 34 receives the expected service from the memory 32 and a second input of the comparator 34 receives the output of the processor 30. The comparator 34 then determines if the datagrams are receiving the service or services that a customer is expecting to receive, or has paid to receive. More specifically, the comparator 34 determines if the expected service was applied appropriately as provisioned.

When a service network node is symmetric, the system of FIG. 1 may be used to determine if datagrams transmitted into the service network 16 were provisioned to receive a similar service as datagrams received from the service network 16. To make this determination, a single flow collector (here, flow collector 22) captures ingress and egress flow activity at a service interface in the service network 16. In FIG. 1, node A includes an ingress interface 36 and an egress interface 38 which send data to the flow collector 22.

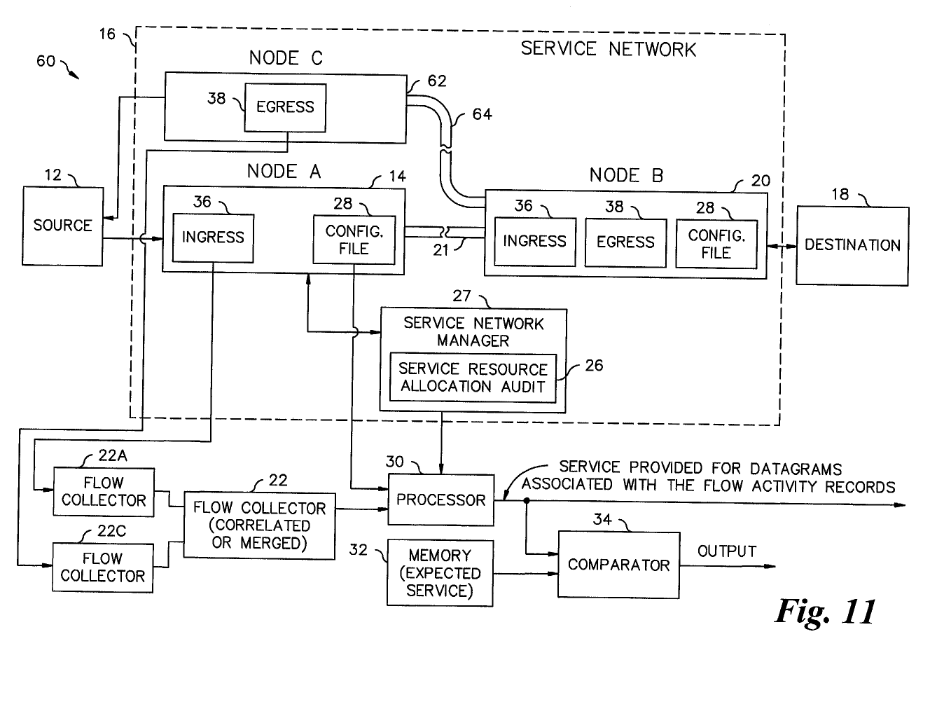

When a service network node is asymmetric, additional flow collectors may be required to capture flow activity in multiple communication paths. The flow records may then be correlated or merged to provide flow records equivalent to those in the flow collector 22. FIG. 11 shows a system 60 which is similar to system 10, except that node A is unidirectional. Another unidirectional node 62 (labeled as node C) is provided. Datagrams to be sent from the source 12 to the destination 18 flow through node A and the communication path 21, whereas datagrams sent from the destination 18 to the source 12 flow through node C via an additional communication path 64. A flow collector 22_{A} captures ingress flow activity at node A, and another flow collector 22_{C} captures egress flow activity at node C. The flow records of the flow collectors 22_{A} and 22_{C} may then be merged to provide flow records equivalent to those in the flow collector 22 of FIG. 1. Alternatively, the nodes A and C may be bidirectional, and, thus may each include an ingress and an egress. In this embodiment, the flow collectors 22_{A} and 22_{C} must receive both ingress and egress flow from the respective nodes A and B. Alternatively, there may be only one flow collector 22 which directly captures flow activity from the ingress 36 of node A and the egress 38 of node B. Whether there are one or two flow collectors 22 depends upon the locations of nodes A and C and the desired data collection configuration.

Regardless of whether the service network is symmetric (FIG. 1) or asymmetric (FIG. 11), and regardless of whether the nodes of the service network are unidirectional (FIG. 11, nodes A and C) or bidirectional (FIG. 1, nodes A and B; FIG. 11, node B), the output of the processor 30 (also represented in FIG. 2 as the ‘service provisioned” column) is used to determine by a comparison operation whether datagrams transmitted into the service network were provisioned to receive a similar service as datagrams received from the service network.

To perform a useful comparison, it may be necessary to consult a table of equivalent services. For example, an ingress entry may have received a service of type 1, whereas an egress entry may have received a service of type 2, when, in fact, type 1 and type 2 service are functionally equivalent and both meet the level of service expected by, or paid by, the customer. The comparison should ideally take into account these factors so that the results of the comparison can clearly identify situations where functionally dissimilar services were received. Alternatively, a service of type 2 may be a better service than a service of type 1. Thus, if a customer expects, or has paid for, a service of type 1, then it would be acceptable to receive a service of type 2 for an egress entry. This type of dissimilar service may not necessarily be a reportable event.

FIG. 5 shows a self-explanatory flowchart of ingress/egress comparison process used for symmetric nodes.

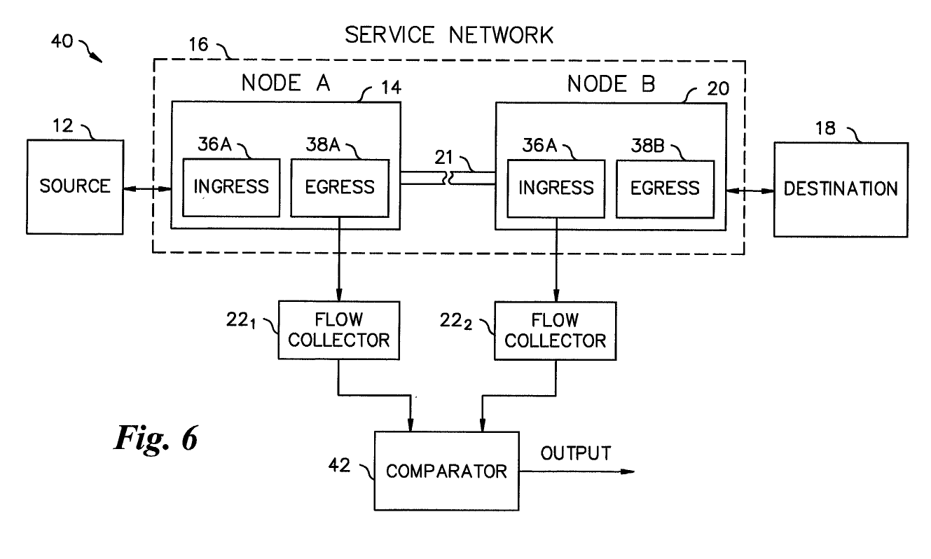

FIG. 6 shows a system 50 that provides an alternative configuration for a service network having symmetric nodes to determine if datagrams transmitted into the service network 16 received a similar service as datagrams received from the service network 16. To make this determination, a first flow collector (here, flow collector 22₁) captures egress flow activity at a first service interface in the service network 16 (here, egress 38_{A}). A second flow collector (here, flow collector 22₂) captures ingress flow activity at a second service interface in the service network 16 (here, ingress 36_{B}). The ingress flow activity is related to the egress flow activity. In comparator 42, the flow descriptors and their time data from the respective flow collectors 22₁ and 22₂ are used to identify ingress and egress flow activity record entries that correspond to each other. The process then continues in the same manner as described above for a symmetric node to determine if datagrams transmitted into the service network received a similar service as datagrams received from the service network. FIG. 6 does not show the audit 26 or configuration file 28, or the service network manager 27, or the processor 30 for identifying the service provided. However, these elements also exist in the FIG. 6 configuration and function in the same manner as described in FIG. 1.

The service identifier discussed above and stored in the flow activity records references a service, such as a security service, a performance service, or another type of network service. Examples of services include bit rate (e.g., CBR, VBR, ABR, UBR), priority (e.g., loss priority, delay priority), encryption, access control, integrity, and authentication. Some examples of service identifiers are provided below. The first five examples illustrate logical interfaces and the last example illustrates a physical interface.

| Service Network | Service Identifier |
|---|---|
| virtual private network (VPN) | one or more of tunnel |
| | identifier, path identifier |
| | (such as an MPLS |
| | tag), connection identifier, |
| | security payload identifier, |
| | security association |
| | identifier, circuit/ |
| | connection identifier |
| asynchronous transfer mode (ATM) network | virtual path identifier/ |
| | virtual circuit identifier |
| | (VPI/VCI) |
| virtual local area network (VLAN) | 802.1Q VLAN identifier |
| label switched path (LSP) network | MPLS tag |
| differentiated services (DiffServ) network | DS byte |
| Layer 2/Layer 3 network (e.g., IP network) | isIndex, a physical interface |
| | identifier, a logical |
| | interface identifier |

FIGS. 1-6 describe the invention in a scenario wherein a single service is being provided to the datagrams flowing through the service network. However, the scope of the invention includes embodiments wherein plural services are simultaneously provided to the datagrams flowing through the service network. For example, interface i₁ may be providing two different services at a given time, or interface i₁ may be in a nested service architecture.

A second embodiment of the present invention captures service labels that are within or appended to datagrams, and stores the service labels in flow activity records. The service labels are then used to audit communication sessions within a service network. The service label may be a dedicated portion of the datagram that only has meaning as a service label. Alternatively, the service label may be a portion of the datagram that has meaning independent of any meaning as a service label. For example, the source or destination address of a datagram may function as a service label (e.g., any traffic going to destination address 123 gets service XYZ). Thus, the entire flow descriptor or a portion of the flow descriptor (which contains the source or destination address information extracted from the datagram) may function as a service label.

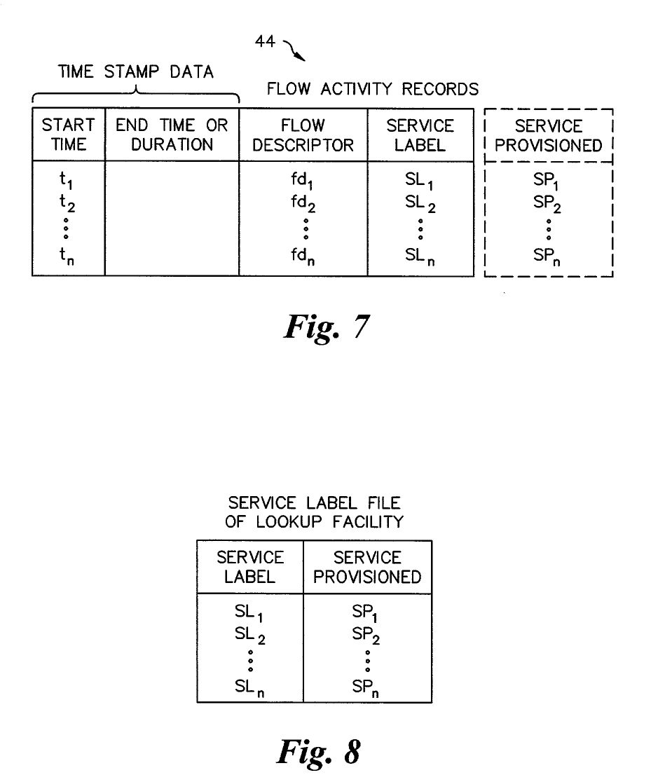

FIG. 7 shows selected content of flow activity records 44 stored in the flow collector 22 in accordance with the second embodiment of the present invention. Each flow activity record entry has a time stamp, a flow descriptor, and any service labels that are within or appended to the datagrams. To simplify the explanation of the present invention, it will be presumed that there is no more than one service label within or appended to each datagram, so that no more than one service is provided. However, the scope of the invention includes embodiments wherein plural service labels are within or appended to the datagrams because plural services may be simultaneously provided. Thus, the present invention can simultaneously audit plural services.

The service labels “reference” a particular service that is provisioned or intended to be given to the datagram. The service labels, per se, do not always communicate the service to be given to the datagram. That is, not all service labels are standardized or universally understood. Thus, a service label file will often be needed to translate the service labels of a particular service network to the service that should be given. FIG. 8 shows such a service label file or lookup facility 46 for one particular service network. Standards/protocols exist regarding where and how service labels should be placed in a datagram. Service labels are often prepended to datagrams, but can also be embedded within a datagram. Accordingly, the service labels can be identified within the datagram and placed in the flow activity record with the corresponding flow descriptor for the datagram.

The system 10 of FIG. 1 and the system 40 of FIG. 2 may also be used for the second embodiment of the present invention. The only difference is that the service label file 46 may be needed. If so, it must be in communication with the processor 30 in the same manner as the configuration file 28 described above.

As noted above, the “service provisioned” information is not actually part of the flow activity records 44. However, in an alternative embodiment of the present invention, the “service provisioned” information may be added as another field of a flow activity record 44 after the information is determined from the process described above.

Once collected, the service labels may be used for a variety of different purposes, summarized below.

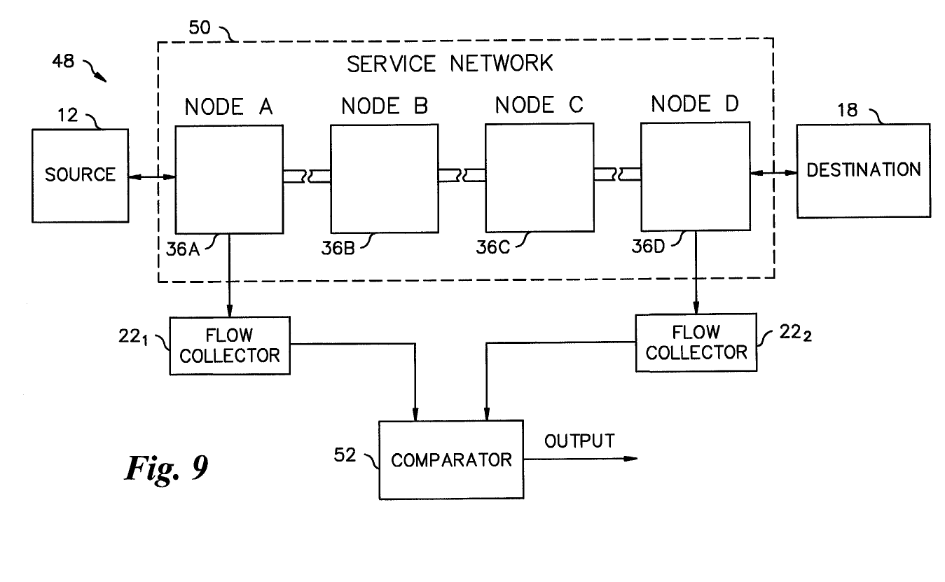

1. Service labels of corresponding flow activity record entries from two different flow collectors (e.g., the first and second flow collectors 22₁, 22₂ in FIG. 6) may be compared to determine if the provisioned service is consistent or has changed. If so, the service label file 46 is consulted to determine what the service label was changed to. A determination can then be made as to whether the change degraded the quality of service that the datagram should have received. FIG. 9 shows a system 48 having a service network 50 with four nodes and flow collectors 22₁, 22₂ at the first and fourth node, respectively, for auditing the service labels as datagrams flow through the service network. A processor 30 identifies flow activity record entries that correspond to each other, and a comparator 52 compares the services received for the corresponding record entries. FIG. 9 does not show the audit 26 or configuration file 28, or the processor 30 for identifying the provisioned service. However, these elements also exist in the FIG. 9 configuration and function in the same manner as described in FIG. 1.

2. The absence of a service label in a flow activity record may indicate that “no service” was provisioned for the datagrams associated with the flow activity record. The absence of a service label may also indicate that the datagrams associated with the flow activity record were provisioned to received a default service. Thus, a review of flow activity records from even a single flow collector 22 placed at a point of interest in the service network 16 or 50 provides very useful audit information.

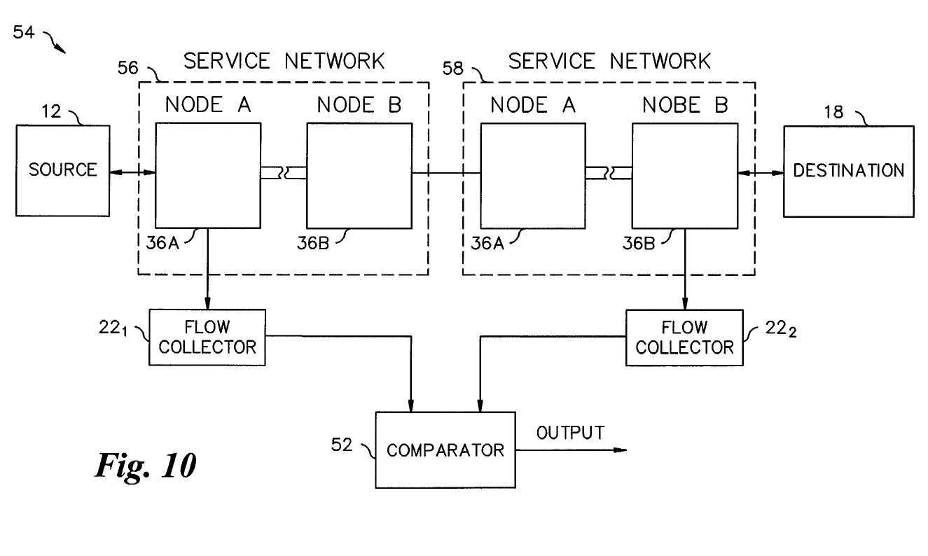

3. Service labels of corresponding flow activity record entries from two or more different flow collectors, each located in different service networks, may be compared to determine if the datagrams are provisioned to receive the same (or better) service as the datagrams flow through plural or nested service networks. FIG. 10 shows a system 54 that illustrates such a configuration. In the system 54, communication between the source 12 and the destination 18 involves two service networks 56 and 58. The comparison process may require the use of plural service label files 46 (not shown), since each service network may have its own service labels that map to certain services to be given. However, if standardized service labels are used in both service networks 56 and 58, then no service label file or lookup facility 46 will be needed to make the comparison. FIG. 10 does not show the audit 26 or configuration file 28, or the processor 30 for identifying the service provided. However, these elements also exist in the FIG. 10 configuration and function in the same manner as described in FIG. 1.

4. The service labels may be used to determine if the expected or intended service (i.e., the service that was supposed to be given to the datagrams corresponding to specified flow descriptors) matches the service that was actually provided. The intended service may be directly determined from the extracted service labels stored in the corresponding flow activity records, or may be indirectly determined from the service label file 46 if the service label is specific to the service network. The service that was actually provided can be determined by the processes described above, such as by using the audit 26 or the configuration file 28.

5. The service labels may be used to determine at a particular point in the service network if an intended or expected service matches the service referenced by the service label captured at the particular point. Elements such as memory 32 and comparator 34 described in FIG. 1 may be used for this purpose.

The service label can reference a security service or a performance service. The particular security service or performance service may depend upon the type of service network. Examples of service networks that are within the scope of the present invention include the following type of networks: VPN, ATM, Ethernet, VLAN and LSP. If the service network is an Ethernet, the service identifier may be a Layer 2 encapsulation header, an 802.10 encapsulation header, an LLC/SNAP encapsulation header, or a Point-to-Point Protocol over Ethernet (PPPOE) encapsulation header.

The service label may be a DiffServ code point within the datagram that indicates the service requirements for the datagram. The service label may be at least one MPLS label or an 802.1Q identifier prepended to the datagram. The service label may also be an IPSec security payload identifier, an Ipv6 flow identifier, a destination service access port (DSAP), a universal resource identifier (URI), or application label data.

In the preferred embodiment of the present invention, flow activity is captured by a flow meter, stored in time-stamped flow activity records of one or more flow collectors, and then the flow activity record entries are used in subsequent correlating, merging, comparing and processing steps. However, the scope of the present invention includes embodiments without flow collectors, as well as embodiments without flow collectors that use elements which perform functions similar to flow collectors.

The methods used by a flow collector to capture flow activity are well-known in the prior art. For the purposes of this invention, a flow collector captures sufficient flow activity information so that the same network activity, captured by multiple independent flow collectors along a given network path, can be unambiguously identified and matched. Flow activity timestamps must represent the time of observation of the same network event, so that comparisons of flow activity timestamps from multiple flow collectors has relevance. To support this requirement, flow collectors may use flow state and flow duration characteristics to determine when to generate flow activity records. Although not a strict requirement, the flow descriptors can include sufficient identifying information so that making the determination that the reported network events are indeed the same, is possible. In the embodiments of the present invention which use a single flow collector, flow activity of selected traffic is captured between the source and the destination at selected states and points in time during the communication session. Examples of flow states include flow start, flow continuance and flow stop.

The present invention may be implemented with any combination of hardware and software. If implemented as a computer-implemented apparatus, the present invention is implemented using means for performing all of the steps and functions described above.

The present invention can be included in an article of manufacture (e.g., one or more computer program products) having, for instance, computer useable media. The media has embodied therein, for instance, computer readable program code means for providing and facilitating the mechanisms of the present invention. The article of manufacture can be included as part of a computer system or sold separately.

Changes can be made to the embodiments described above without departing from the broad inventive concept thereof. The present invention is thus not limited to the particular embodiments disclosed, but is intended to cover modifications within the spirit and scope of the present invention.

[image]

[image]

[image]

[image]

[image]

[image]

[image]

[image]

What is claimed is:

1. A method of auditing a communication session between a source connected to a first node of a service network and a destination connected to a second node of the service network, the method comprising:
(a) capturing flow activity of selected traffic between the source and the destination at selected states and points in time during the communication session, including:
(i) a flow descriptor for selected datagrams placed in the service network, and
(ii) a service identifier for the selected datagrams which identifies a service interface in the service network that the datagram is transmitted to or received from; and
(b) identifying the service being provisioned on predefined service interfaces; and
(c) using the identified provisioned service and the service identifiers to determine the service provisioned for the datagrams associated with the captured flow activity.

2. The method of claim 1 further comprising:
(d) using the flow descriptors and their time data to identify ingress and egress flow activity that corresponds to each other; and
(e) comparing the services provisioned for the corresponding entries to determine if datagrams transmitted into the service network were provisioned to receive a similar service as datagrams received from the service network.

3. The method of claim 2 wherein a single flow collector captures the ingress and egress flow activity records at a service interface in the service network, and steps (d) and (e) are performed using the flow activity record entries in the single flow collector.

4. The method of claim 2 wherein a first flow collector captures egress flow activity records at a first service interface in the service network, and a second flow collector captures ingress flow activity records at a second service interface in the service network, and steps (d) and (e) are performed using the flow activity record entries in the second and first flow collectors that correspond to each other.

5. The method of claim 1 further comprising:
(d) storing the flow activity in time-stamped flow activity records in at least one flow collector.

6. The method of claim 1 wherein step (a) is performed by a flow meter.

7. The method of claim 1 wherein the service network is a dynamic service network which continuously creates a service resource allocation audit that specifies the service being provided on interfaces of the service network at selected periods of time, wherein step (c) further comprises using portions of the audit having time data which is correlatable to the flow activity to determine the service provisioned for the datagrams associated with the captured flow activity.

8. The method of claim 1 wherein the service network is a non-dynamic service network and a configuration file stores the service being provided on interfaces of the service network, wherein step (c) further comprises using the data in the configuration file to determine the service provisioned for the datagrams associated with the captured flow activity.

9. The method of claim 1 further comprising:
(d) storing in a memory an expected service to be provisioned for the traffic between the source and the destination; and
(e) in a comparator, comparing the service determined in step (c) to be provisioned for the datagrams with the expected service to be provisioned stored in the memory to determine if the expected service was provisioned.

10. The method of claim 1 wherein the service identifier references a security service or a performance service.

11. The method of claim 1 wherein the service network is a virtual private network.

12. The method of claim 1 wherein the service network is an asynchronous transfer mode (ATM) network.

13. The method of claim 1 wherein the service network is a virtual local area network (VLAN).

14. The method of claim 1 wherein the service network is a label switched path (LSP) network.

15. The method of claim 1 wherein the service network is a Layer 2 or Layer 3 network, and the service identifier is a physical interface identifier.

16. A method of auditing a communication session between a source connected to a first node of a service network and a destination connected to a second node of the service network, the method comprising:
(a) capturing flow activity of selected traffic between the source and the destination at selected states and points in time during the communication session, including:
(i) a flow descriptor for selected datagrams placed in the service network, and
(ii) any service labels that are within or appended to the selected datagrams, the service labels referencing the service to be given to the datagram;
(b) identifying a provisioned service being referenced by the service label; and
(c) using the identified provisioned service and the service labels of the captured flow activity to determine the services provisioned for the datagrams associated with the captured flow activity.

17. The method of claim 16 further comprising:
(d) storing the flow activity in time-stamped flow activity records in at least one flow collector.

18. The method of claim 16 wherein the flow activity is captured at a plurality of locations in or at interfaces of the service network, the method further comprising:
(d) using the flow descriptors and their time data to identify flow activity that correspond to each other; and
(e) comparing the provisioned service for the corresponding entries to determine if the datagrams associated with the flow activity were provisioned to receive a similar service.

19. The method of claim 16 wherein the specified service is a security service or a performance service.

20. The method of claim 16 wherein step (a) is performed by a flow meter.

21. The method of claim 16 wherein the flow activity is captured in or at the interface of the service network, the method further comprising:
(d) storing in a memory an expected service to be provisioned for the traffic between the source and the destination; and
(e) in a comparator, comparing the service determined in step (c) to be provisioned for the datagrams with the expected service to be provisioned stored in the memory to determine if the expected service was provisioned.

22. The method of claim 16 wherein a service label lookup facility stores the service labels used by the service network and the provisioned service being referenced by the service label, wherein step (c) further comprises using the service labels captured in the flow activity and the data in the service label file to determine the services provisioned for the datagrams associated with the captured flow activity.

23. The method of claim 16 wherein the absence of any service labels in selected flow activity indicates that no service or a default service was provisioned for the datagrams associated with the flow activity.

24. The method of claim 16 wherein the service network is a virtual private network (VPN).

25. The method of claim 16 wherein the service label is a DiffServ code point within the datagram that indicates the service requirements for the datagram.

26. The method of claim 16 wherein the service label is at least one MPLS label prepended to the datagram.

27. The method of claim 16 wherein the service label is an 802.1Q VLAN identifier prepended to the datagram.

28. The method of claim 16 wherein the service label is an IPSec security payload identifier.

29. The method of claim 16 wherein the service label is an Ipv6 flow identifier.

30. The method of claim 16 wherein the service label is the source arid/or destination address of the datagram.

31. The method of claim 16 wherein the service label is the destination service access port (DSAP).

32. The method of claim 16 wherein the service label is the universal resource identifier (URI).

34. The method of claim 16 wherein the service label is application label data.
